(19) United States
(12) Patent Application Publication
(10) Pub. No.: US 2006/0007083 A1
(43) Pub. Date: Jan. 12, 2006

(54) Display panel and driving method thereof

(75) Inventors: Feng-Ting Pai, Hsinchu (TW); Ssu-Ming Lee, Tucheng City (TW); Hsien-Wen Chou, Yangmei Town (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Hannstar Display Corp.

(21) Appl. No.: 11/053,112

(22) Filed: Feb. 8, 2005

(30) Foreign Application Priority Data
Jun. 24, 2004 (TW) 93118266

(51) Int. Cl. G09G 3/36

(52) U.S. Cl. 345/87

(57) ABSTRACT

A display panel comprising a plurality of data lines, a plurality of scan lines, a display array, a data driver, and a scan driver. The data driver defines N data sections as one group and inserts a predetermined image section into the group. When the scan driver sequentially drives the N scan lines related to the group of the N data sections according to a first start pulse, the data driver provides the group of the N data sections to the pixels. When the scan driver sequentially drives the N scan lines related to the group of the C data sections according to a second start pulse, the data driver provides the predetermined image section to the pixels.

### BACKGROUND

The invention relates to a display panel, and in particular to a driving method for a display panel.

FIG. 1 is a schematic diagram of a conventional liquid crystal display (LCD). The LCD 1 comprises a low voltage differential signaling (LVDS) module 10, a memory device 11, a timing controller 12, and a panel 13. The panel 13 comprises a data driver 14, a scan driver 15, and a display array 16. The data driver 14 controls a plurality of data lines D₀ to D_{X}, and the scan driver 15 controls a plurality of scan lines G₀ to G_{Y}. The display array 16 is formed by interlacing data lines D₀ to D_{X} and scan lines G₀ to G_{Y}. Each interlacing data line and scan line corresponds to a pixel, for example, interlacing data line D₀ and scan line G₀ correspond to pixel 16a.

The LVDS module 10 receives picture data and provides data enable signals, vertical synchronizing signals, horizontal synchronizing signals, and synchronizing clock to the timing controller 12. In addition, the LVDS module 10 provides picture data to the memory device 11. Data signals are provided to the data driver 14 and a scan control signal is provided to the scan driver 15 by the timing controller 12 in response to the data enable signals, vertical synchronizing signals, horizontal synchronizing signals, and the synchronizing clock. When the scan driver 15 drives thin film transistors (TFTs) in pixels 16a, the data driver 14 provides data signals thereto. The memory device 11 receives data signals from the timing controller 12 and picture data from the LVDS module 10. Using the picture data and the data signals, the memory device 11 provides even and odd numbered signals required to drive the data signals in the data driver 14.

FIG. 2 is a timing diagram of the conventional LCD of FIG. 1. The scan driver 15 sequentially outputs gate signals SG₀ to SG_{Y} to the scan lines G₀ to G_{Y} according to the scan control signal. For example, when receiving a gate signal, the scan line G₀ turns on the TFTs within all pixels in a row corresponding to the scan line G₀, while the TFTs within all pixels in all other rows are turned off by other scan lines. When the TFTs within all pixels in a row are all turned on, the data driver 14 outputs the corresponding data signal SD₀ to the pixels in row through the data lines D₀ to D_{X}. Each time the scan driver 15 finishes scanning all scan lines G₀ to G_{Y}, the operation displaying a single frame is completed. Thus, image display is achieved by repeatedly scanning scan lines G₀ to G_{Y} and outputting data signals SD₀ to SD_{Y}.

The conventional LCD in. FIG. 1 has a problem in that the image of a previous frame may overlap into a next frame due to the response time of a pixel. FIG. 3 shows the response of a pixel changing from one data state DL1 to another data state DL2. A pixel, such as pixel 16a, has the data level DL1 during a first frame F1. Subsequently, the pixel 16a has the data state level DL2 during a second frame F2. However, there is a delay when the pixel transfers from the first level DL1 to the second level DL2 that creates blur on the screen. The appearance of blur impedes the application of dynamic display.

### SUMMARY

A display panel is provided. The display panel comprising a plurality of data lines, a plurality of scan lines, a display array, a data driver, and a scan driver. The display array comprises a plurality of pixels, each corresponding to a set of the interlacing data line and scan line. The data driver controls the data lines. The scan driver controls the scan line. The data driver defines N data sections as one group and inserts a predetermined image section into the group. When the scan driver sequentially drives the N scan lines related to the group of the N data sections according to a first start pulse, the data driver provides the group of the N data sections to the pixels through the data lines. When the scan driver drives the scan lines related to the group of the N data sections according to a second start pulse, the data driver provides the predetermined image section to the pixels through the data lines.

### DESCRIPTION OF THE DRAWINGS

The invention will become more fully understood from the detailed description given hereinbelow and the accompanying drawings, given by way of illustration only and thus not intended to be limitative of the invention.

FIG. 1 is a schematic diagram of a conventional liquid crystal display;

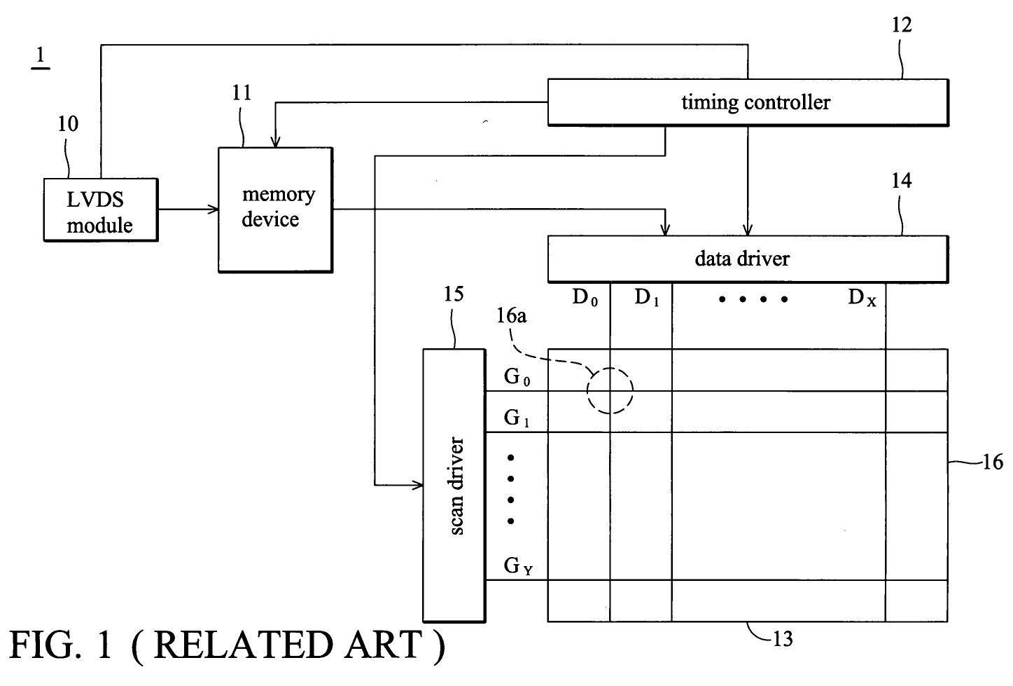

FIG. 2 is a timing diagram for the conventional LVD of FIG. 1;

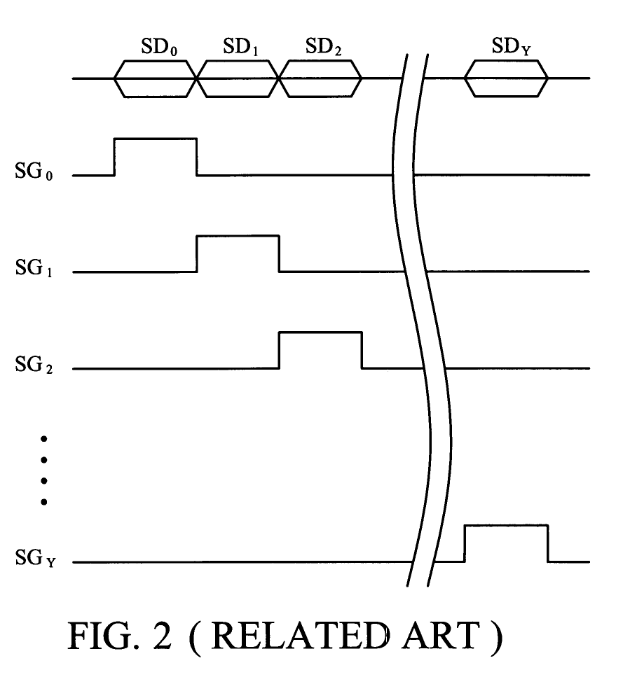

FIG. 3 shows the response of a pixel changing from one data state to another data state;

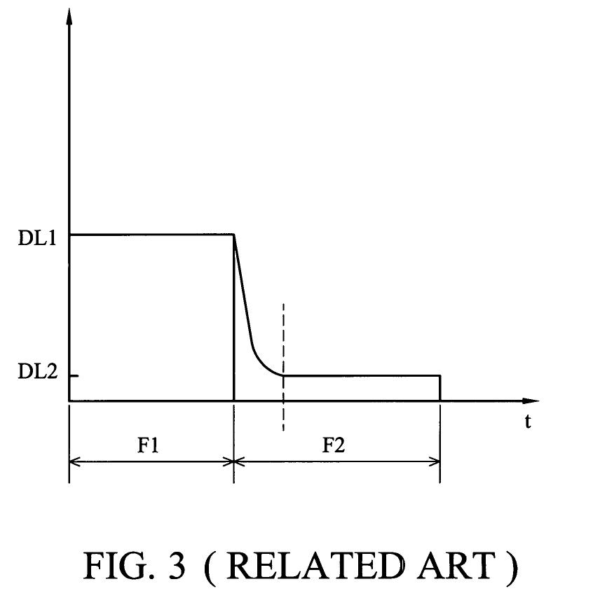

FIG. 4 shows an embodiment of an LCD panel;

FIG. 5 is a timing diagram for the embodiment of the LCD in FIG. 4;

FIG. 6 shows states of the control signals corresponding to the residuary data sections; and

FIG. 7 is a flow diagram of an embodiment of a driving method for a display panel.

### DETAILED DESCRIPTION

LCD panels are provided. In some embodiments, after displaying an image of a frame for a predetermined time, a pixel displays a black image, a white image, or any image of a predetermined gray scale value until the pixel displays an image of a next frame. The image of a previous frame will not overlap in to a next frame, preventing blur phenomenon.

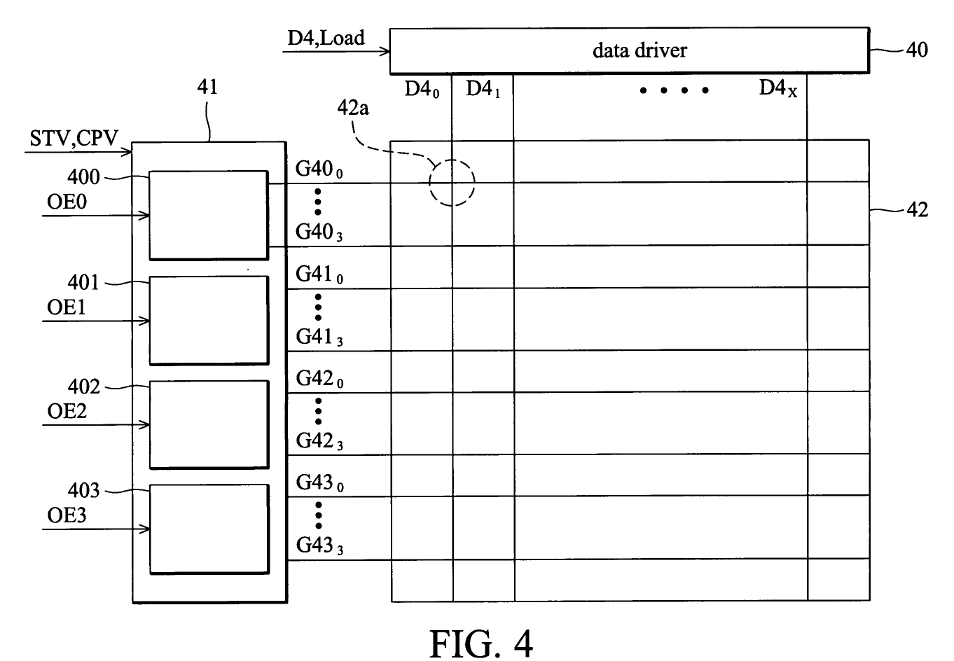

FIG. 4 shows an embodiment of an LCD panel. The panel 4 comprises a data driver 40, a scan driver 41, and a display array 42. The data driver 40 controls data lines D4₀ to D4_{X}. The scan driver 41 comprises a plurality of driving units, such as driving units 400 to 403, each controlling a plurality of scan lines. In this embodiment, each driving unit controls four scan lines to conveniently illustrate the operation of the LCD panel in FIG. 4. For example, the driving unit 400 controls the scan lines G40₀ to G40₃. The display array 42 comprises a plurality of pixels. Each set of interlacing data line and scan line corresponds to a pixel, for example, the interlacing data line D4₀ and scan line G40₀ correspond to the pixel 42a.

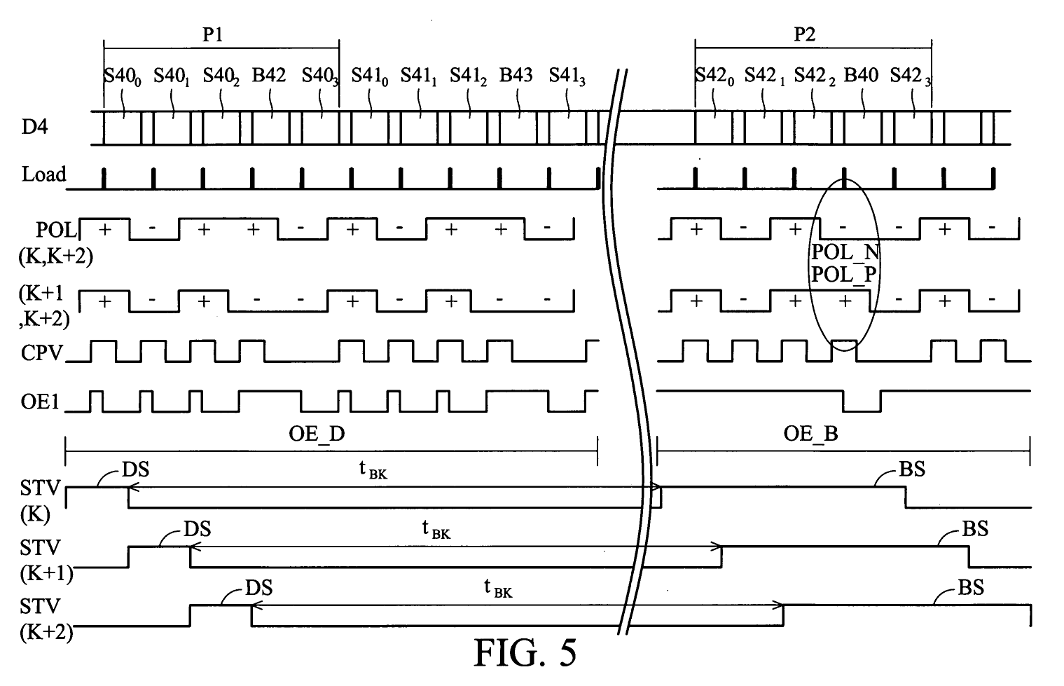

The scan driver 41 receives a gate clock signal CPV, a start vertical signal STV, and gate-on enable signals OE0 to OE3. The gate-on enable signals OE0 to OE3 are respectively provided to the driving units 400 to 403. Each gate-on enable signal has a waveform OE_D or a waveform OE_B (referring to FIG. 5).

Data driver 40 receives a data signal D4 and a load signal Load. The data signal D4 is partitioned into M data sections, each corresponding to the pixels on one scan line, so that M is equal to a number of scan lines. Every N data sections among the M data sections are defined as a group, and a black image section, a white image section, or an image section of a predetermined gray scale value is inserted into each group. In the embodiment in FIG. 4, one black image section is inserted into every four data sections, that is, four (N=4) sections are defined as a group corresponding to four scan lines, and a black image section is inserted into the group.

Referring to FIGS. 4, and 5, for example, the data sections S40₀ to S40₃ are defined as a group P1 and correspond to the pixels along the scan lines G40₀ to G40₃ respectively. A black image section B42 is inserted between the data sections S40₂ and S40₃ in the group P1. The load signal Load indicates that each data section of the data signal D4 is loaded into the pixels on the corresponding scan line. The start vertical signal STV comprises two pulses DS and BS. The pulse DS indicates that a period (hereinafter referred to as “first process”) in which the data sections are loaded into the pixels on the scan lines begins, and the gate-on enable signal OE0 is in the waveform OE_D during the first process. The pulse BS indicates that a period (hereinafter referred to as “second process”) in which the black image sections are loaded into the pixels on the scan lines begins, and the gate-on enable signals OE0 is in the waveform OE_B during the second process.

Referring to FIG. 5, when the pulse DS occurs on the start vertical signal STV, the first process starts and the driving units 400 to 403 operate sequentially. During the first process, the driving units 400 sequentially drive the scan lines G40₀ to G40₃ according to the rising edge of the gate clock signal CPV and the waveform OE_D of the gate-on enable signals OE0, and then the data driver 40 sequentially loads the data sections S40₀ to S40₃ into the pixels on the scan lines G40₀ to G40₃ according to the load signal Load. It is noted that the waveform OE_D corresponding to the black image section B42 remains at a high level to block the black image section B42 from being loaded into the pixels along the scan lines G40₀ to G40₃.

The driving units 401 to 403 also perform the operation described above in the first process. After the first process is performed for a predetermined interval t_{BK}, the pulse BS occurs on the start vertical signal STV, so that the second process starts and the driving units 400 to 403 operate sequentially. In the embodiment in FIGS. 4 and 5, the pulse BS occurs on the start vertical signal STV at the time when the pixels on the scan lines G42₀ to G42₃ controlled by the driving unit 402 begin receiving the data sections S42₀ to S42₃. During the second process, the driving unit 400 sequentially drives the scan lines G40₀ to G40₃ according to the rising edge of the gate clock signal CPV. The data driver 40 then loads the black image section B40 into the pixels along the scan lines G40₀ to G40₃ of the group simultaneously according to a low level of the waveform OE_B. Similarly, the driving units 401 to 403 perform the operation described above in the second process.

According to the embodiment in FIGS. 4 and 5, during the first process, the scan lines in one group are sequentially driven, and the data sections are sequentially loaded into the driven scan lines. After the first process is performed for a predetermined time, the second process begins, and a black image section is loaded into pixels on the scan lines in the group simultaneously. Moreover, the first process and the second process are simultaneously performed and respectively correspond to different groups of scan lines.

The predetermined interval t_{BK} between the pulses DS and BS is determined according to requirements of the LCD panel. However, to display images correctly and maintain regular timing, the predetermined interval t_{BK} must exceed the total time for all pixels corresponding to one driving unit to receive the data sections.

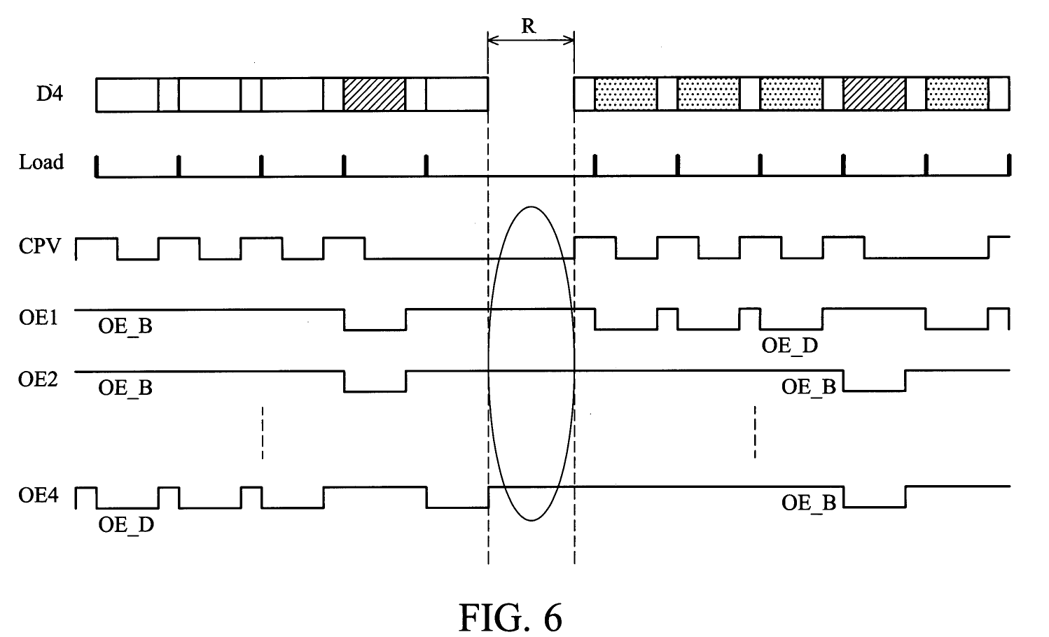

In the embodiment in FIG. 4, four (N=4) data sections are defined as one group, with M preferably a multiple of 4. If M is not a multiple of 4, the gate clock signal CPV, the load signal Load, and the gate-on enable signals OE0 to OE3 are paused during a period corresponding to the residual data sections. As shown by the marked cycle in FIG. 6, during a period R corresponding to the residual data sections, the gate clock signal CPV, the load signal Load, and the gate-on enable signals OE0 to OE3 remain in the previous respective state.

Referring to FIG. 5, during the pulse DS of the start vertical signal STV in the first process, polarities of the data sections are determined according to a state of a polarity signal corresponding to the pulse DS. For example, in the Kth frame, a polarity signal POL (K) corresponding to the pulse DS is positive, and the polarities of the data sections are determined as “+−+− . . . ”. In the (K+1)th frame, a polarity signal POL (K+1) corresponding to the pulse DS is negative, and the polarities of the data sections are determined as “−+−+ . . . ”. In the second process, polarities of the black image sections are determined according to the polarity signal POL corresponding to the waveform OE_B and switch states during the pulse BS. As shown by the marked cycle in FIG. 5, in the Kth frame, a low level of the waveform OE_B corresponds to a pulse POL_N of the polarity signal POL (K), and the polarity of the black image section B40 is negative. In the (K+1)th frame, the low level of the waveform OE_B corresponds to a pulse POL_P of the polarity signal POL (K+1), and the polarity of the black image section B40 is positive. Thus, the polarities of the data sections are switched every scan line, and the polarities of the black image sections are switched each frame.

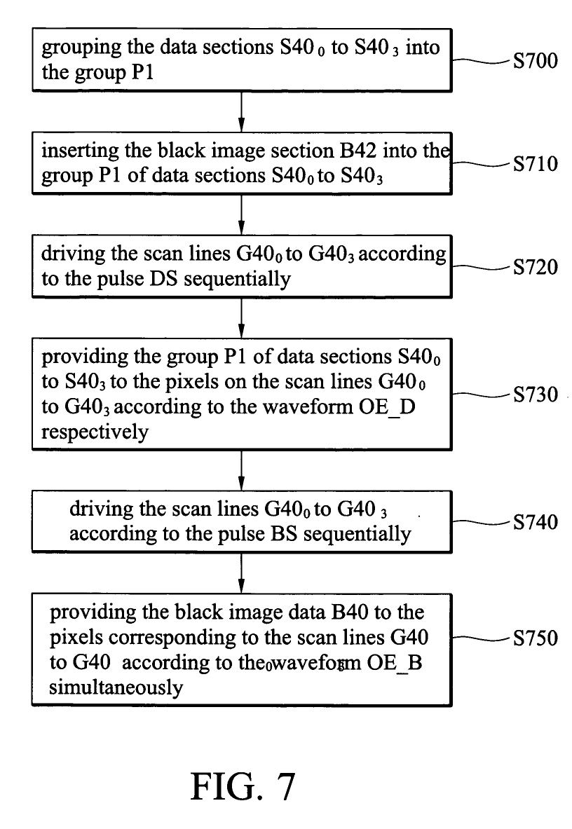

FIG. 7 is a flow diagram of an embodiment of a driving method for a display panel. Referring to FIGS. 4, 5, and 7, every four (N=4) data sections, such as the data sections S40₀ to S40₃, are grouped into the group P1 (step S700), and the data sections S40₀ to S40₃ correspond to the scan lines G40₀ to G40₃ respectively. The black image section B42 is inserted into the group P1 of data sections S40₀ to S40₃ (step S710). The scan lines G40₀ to G40₃ are driven by the driving unit 400 according to the pulse DS sequentially (Step S720). The group P1 of data sections S40₀ to S40₃ are provided to the pixels on the scan lines G40₀ to G40₃ according to the waveform OE_D of the gate-on enable signal OE1 respectively (Step S730). The scan lines G40₀ to G40₃ are driven by the driving unit 400 according to the pulse BS sequentially (Step S740), and the black image data B40 is simultaneously provided to the pixel corresponding to the scan lines G40₀ to G40₃ according to the waveform OE_B of the gate-on enable signal OE1 (Step S750).

Thus, every N data sections among M data sections are defined as a group, and a black image section or a white image section is inserted into the group. The relative relationship between data sections and control signals, such as load signal, gate clock signal, polarity signal, start vertical signal, or gate-on enable signal, is fixed. A black image section or a white image section can be inserted in any position, and the control signals have to shift relatively.

Finally, while the invention has been described by way of preferred embodiment, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A display panel comprising:
a plurality of data lines;
a plurality of scan lines;
a display array comprising a plurality of pixels, each corresponding to a set of interlacing data line and scan line;
a data driver controlling the data lines; and
a scan driver controlling the scan line;
wherein, the data driver defines N data sections as one group and inserts a predetermined image section into the group;
wherein, when the scan driver sequentially drives the N scan lines related to the group of the N data sections according to a first start pulse, the data driver provides the group of the N data sections to the pixels through the data lines; and
wherein, when the scan driver sequentially drives the N scan lines related to the group of the N data sections according to a second start pulse, the data driver provides the predetermined image section to the pixels through the data lines.

2. The display panel as claimed in claim 1, wherein the relative relationship between the data sections and a plurality of control signals provided to the display panel is fixed.

3. The display panel as claimed in claim 2, wherein the control signals comprise a load signal, a gate clock signal, a polarity signal, a start vertical signal, and a gate-on enable signal.

4. The display panel as claimed in claim 3, wherein the start vertical signal is composed of the first and second start pulses, the first start pulse is related to the data sections, and the second start pulse is related to the predetermined image section.

5. The display panel as claimed in claim 4, wherein polarities of the data sections are determined according to a state of the polarity signal corresponding to the first start pulse.

6. The display panel as claimed in claim 3, wherein when a total number of scan lines is not a multiple of N, the load signal, the gate clock signal, the polarity signal, a start vertical signal, and the gate-on enable signal are paused during a period corresponding to the residuary data sections.

7. The display panel as claimed in claim 1, wherein the predetermined image section is any image data of single gray scale value.

8. The display panel as claimed in claim 7, wherein the predetermined image section is a black image section or white image section.

9. The display panel as claimed in claim 1, wherein the scan driver comprises at least one driving unit receiving a gate-on enable signal allowing the pixels corresponding to the N scan lines to receive the group of the N data sections according to a first waveform of the gate-on enable signal and receive the predetermined image section according to a second waveform of the gate-on enable signal.

10. The display panel as claimed in claim 9, wherein a polarity of the predetermined image section is determined according to a state of a polarity signal corresponding to the second waveform of the gate-on enable signal and is switched during the second start pulse.

11. A driving method for a display panel, the display panel comprising a plurality of data lines, a plurality of scan lines, and a plurality of pixels respectively positioned at an intersection of each data line and scan line, the driving method comprising:
defining N data sections as a group;
inserting a predetermined image section into the group of the N data sections;
driving the N scan lines related to the group of the N data sections according to a first start pulse sequentially;
providing the group of the N data sections to the pixels through the data lines;
driving the N scan lines related to the group of the N data sections according to a second start pulse; and
providing the predetermined image section to the pixels through the data lines simultaneously.

12. The driving method as claimed in claim 11, wherein the relative relationship between the data sections and a plurality of control signals provided to the display panel is fixed

13. The driving method as claimed in claim 12, wherein the control signals comprise a load signal, a gate clock signal, a polarity signal, a start vertical signal, and a gate-on enable signal.

14. The driving method as claimed in claim 13, wherein the start vertical signal is composed of the first and second start pulses, the first start pulse is related to the data sections, and the second start pulse is related to the predetermined image section.

15. The driving method as claimed in claim 14, wherein polarities of the data sections are determined according to a state of the polarity signal corresponding to the first start pulse.

16. The driving method as claimed in claim 13, wherein when a total number of the scan lines is not a multiple of N, the control signals are paused during a period corresponding to the residual data sections.

17. The driving method as claimed in claim 11, wherein the predetermined image section is any image data of signal gray scale value.

18. The driving method as claimed in claim 17, wherein the predetermined image section is a black image section or white image section.

19. The driving method as claimed in claim 11 further comprising:
providing the group of data sections to the pixels on the scan lines related to the group according to a first waveform of a gate-on enable signal, and
providing the predetermined image section to the pixels corresponding to the N scan lines related to the group of the N data sections according to a second waveform of the gate-on enable signal.

20. The driving method as claimed in claim 19, wherein a polarity of the predetermined image section is determined according to a state of a polarity signal corresponding to the second waveform of the gate-on enable signal and is switched during the second srat pulse.
